(19) United States
(12) Patent Application Publication
(10) Pub. No.: US 2010/0057238 A1
(43) Pub. Date: Mar. 4, 2010

(54) SUPPLY PLANNING SYSTEM, PROGRAM THEREOF, AND SYNTHETIC METHOD

(76) Inventors: Tazu NOMOTO, Yokohama (JP); Ken IGARASHI, Miura (JP); Katsunari IKEZAWA, Fujisawa (JP); Takaaki KOMURA, Yokohama (JP)

Correspondence Address: MCDERMOTT WILL & EMERY LLP, 600 13TH STREET, N.W., WASHINGTON, DC, 20005-3096, US

(21) Appl. No.: 12/533,547

(22) Filed: Jul. 31, 2009

(30) Foreign Application Priority Data
Aug. 28, 2008 (JP) 2008-219793

(51) Int. Cl. G06F 19/00

(52) U.S. Cl. 700/103; 700/107

(57) ABSTRACT

The present invention is directed to a technique to easily establish a supply plan which optimizes multiple evaluation indexes on the basis of the priorities of the multiple evaluation indexes. When the number of evaluation indexes stored in the evaluation index storage area is larger than a predetermined threshold, a processing is repeated for specifying two evaluation indexes from those stored in the evaluation index storage area, and synthesizing the specified evaluation indexes by using a weighing factor, until the number of evaluation indexes becomes equal to or less than the threshold.

### FIELD OF THE INVENTION

The present invention relates to a supply planning technique which satisfies a predetermined constraint condition and optimizes multiple evaluation indexes.

### DESCRIPTION OF THE RELATED ART

In a manufacturing industry, a supply plan (determining choice of production sites, products profile, production volume and timing of launching manufacturing and shipment) is established, in response to a sales plan (determining choice of sales offices, products profile, sales figures and timing of launching sales) that is established by a business section or a sales company. A person in charge of planning checks constraints in production site and in transportation to achieve a feasible supply plan. Furthermore, in order to mature a supply plan, multiple evaluation indexes such as a production cost, a transportation cost, and a sales amount are used to evaluate and establish the supply plan.

There are suggested techniques using a linear programming and a mixed integer programming, which are techniques to calculate a production plan, a possible production quantity, and a transportation plan, which optimize multiple evaluation indexes, under the constraint condition regarding the production and transportation on the basis of the sales plan.

The linear programming and the mixed integer programming include the constraint condition and an objective function described in a linear equation, and they are algorithms to search a solution space satisfying the constraint condition, for a variable value that makes the objective function to be optimum (minimum or maximum).

Here, it is necessary to describe the objective function in the form of one primary expression. Therefore, in order to formulate multiple evaluation indexes as the objective function, weights are assigned for converting the indexes into one primary expression. By way of example, according to the technique described in Japanese unexamined patent application publication No. 2004-157922 (hereinafter referred to as “patent document 1”), multiple evaluation criterion are combined using multiple weighting factors when a quantity of a received order is reserved in a manufacturable range.

### SUMMARY OF THE INVENTION

With the progress of globalization, consolidation of companies, and the like in recent years, many businesses have tended to increase the number of sales sites and production sites to be controlled, and the number of product types. In association with such tendency, the size of object data used for calculation as the constraint condition and the objective function is also increasing.

Due to the expansion of the tendency, since the supply planning is related to planning of a plurality of sites, in many cases, a person in charge of planning at the sales site or at the production site is likely to check or adjust the supply plan. In particular, the evaluation indexes of the supply plan on the side of the sales site often differ from those of the production site. By way of example, it is desirable for the sales site to establish a supply plan which constantly ensures a delivery time of the sales plan, whereas the production site focuses much on a production cost and an operating ratio. If such discrepancies are emerged, the persons responsible for the planning conduct a consultation with each other to define priorities of evaluation indexes.

In order to calculate the supply plan considering the priorities of the evaluation indexes, it is necessary to obtain optimum solutions, the number of which corresponds to the number of the priorities, but it may augment a calculation time if the size of data is large.

With regard to the point above, the technique as disclosed in the patent document 1, which is a method for converting the evaluation indexes into one primary expression by assigning weights, involves risks that reversal of priority may occur. On the other hand, if a difference between the weighting factors is set to be sufficiently large to prevent the occurrence of the priority reversal, there is a possibility that a computer may not obtain a solution due to the limited number of significant figures.

In view of the problems above, an object of the present invention is to provide a technique to easily establish a supply plan which optimizes multiple evaluation indexes on the basis of the priorities of the multiple evaluation indexes.

In order to solve the problem above, the present invention demonstrates repeating a processing to synthesize two evaluation formulas into one evaluation formula, in accordance with priorities, until the number of the evaluation formulas becomes a predetermined number.

By way of example, the present invention is directed to a supply planning system for establishing a supply plan by specifying variable values among the variable values which satisfy a predetermined constraint condition, aiming to optimize values of calculation formulas of multiple evaluation indexes, the system further including a controller for repeatedly executing, if the number of the evaluation indexes is larger than a predetermined threshold;

a processing for calculating a value range of each of the calculation formulas respectively for two evaluation indexes, in association with the variable values satisfying the constraint condition, the two evaluation indexes being specified from the multiple evaluation indexes, a processing for calculating a weighting factor by which the calculation formula of one evaluation index out of the two evaluation indexes being specified is multiplied, so that when the one evaluation index is multiplied by the weighting factor, the value range of the calculation formula of the one evaluation index in association with the variable values satisfying the constraint condition becomes larger than the value range of the calculation formula of the other evaluation index in association with the variable values satisfying the constraint condition, and a processing for multiplying the calculation formula of the one evaluation index by the weighting factor and adding a result of the multiplication to the calculation formula of the other evaluation index, thereby synthesizing the two evaluation indexes to obtain one evaluation index.

As described above, according to the present invention, it is possible to easily establish a supply plan that optimizes multiple evaluation indexes on the basis of the priorities of multiple evaluation indexes.

### BRIEF DESCRIPTION OF DRAWINGS

FIG. 1 is a schematic diagram of the supply planning system;

FIG. 2 is a schematic diagram for explaining a distribution of goods;

FIG. 3 is a schematic diagram of sites;

FIG. 4 is a schematic illustration of the sales planning table;

FIG. 5 is a schematic illustration of the supply table;

FIG. 6A is a schematic illustration of the first process table;

FIG. 6B is a schematic illustration of the second process table;

FIG. 6C is a schematic illustration of the time table;

FIG. 7 is a schematic illustration of the priority table;

FIG. 8 is a schematic illustration of the supply planning table;

FIG. 9 is a schematic diagram of the computer;

FIG. 10 is a flowchart showing a processing to establish the supply plan;

FIG. 11 is a flowchart showing a synthetic processing of the evaluation indexes;

FIG. 12 is a schematic illustration of the PMAX setting information table;

FIG. 13 is a schematic diagram of the supply planning system;

FIG. 14 is a schematic illustration of the priority table;

FIG. 15 is a schematic illustration of the comparison table;

FIG. 16 is a schematic illustration of the first supply planning table; and

FIG. 17 is a schematic illustration of the second supply planning table.

### DESCRIPTION OF THE PREFERRED EMBODIMENTS

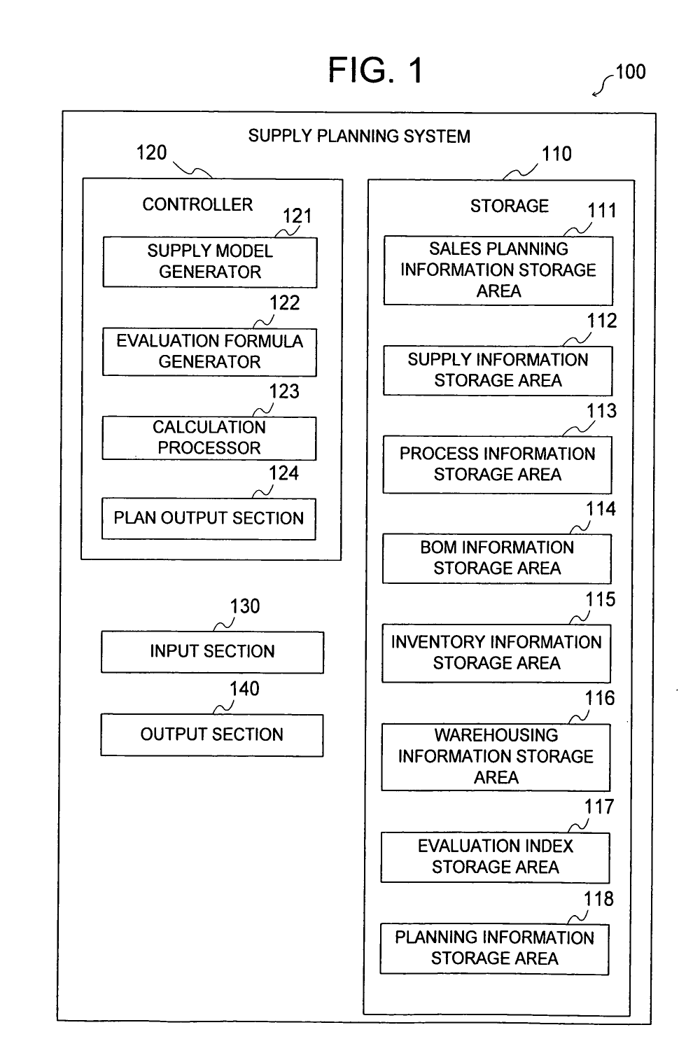

FIG. 1 is a schematic diagram showing the supply planning system 100 according to a first embodiment of the present invention.

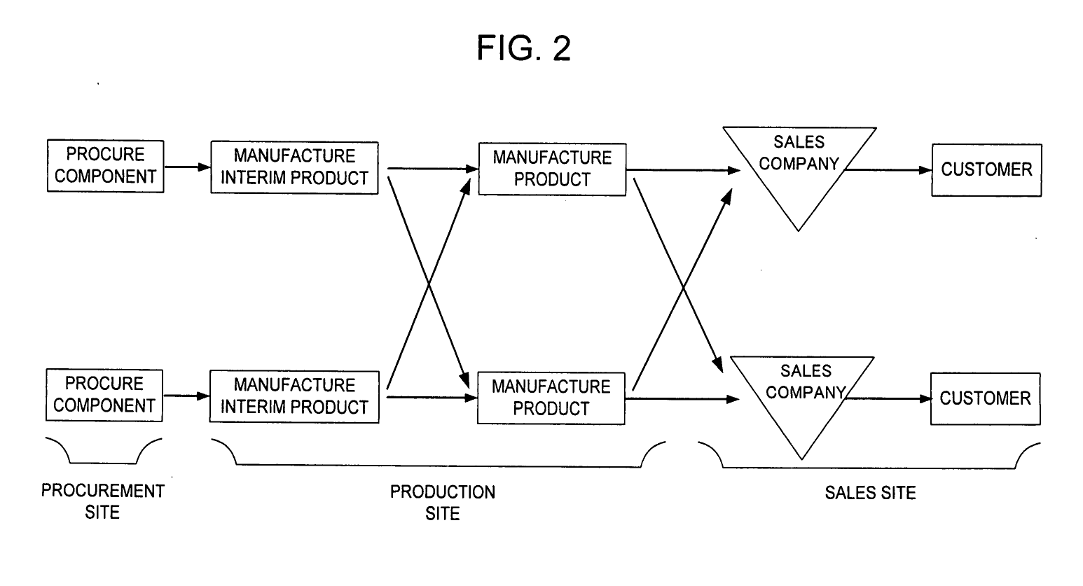

Here, in the present embodiment, an explanation will be made taking as an example a situation where a supply plan is established for a distribution channel described as the following; as shown in FIG. 2 (a schematic diagram for explaining a distribution of goods), at the production site, components are procured from a procurement site to manufacture an interim product being large in configuration, and a product is manufactured from the interim product. Then, the production site makes shipments of the product to the sales site, and after the shipped product is once delivered to a sales company at the sales site, the product is further delivered to a customer.

It is to be noted that if the product is not an assembly, for example, edible oil or the like, it is possible to assume the component and the interim product respectively as a raw material and an intermediate product, such as crude oil indicating the component, refined oil indicating the intermediate product, and bottled oil indicating the product. Accordingly, the present invention can be applied to general usage. In addition, supplying of products from the production site to the sales site may be performed from multiple production sites. There may be multiple transportation means for supplying, such as a ship and an airplane, an ordinary mail and an express mail, which are different in transportation cost and supplying lead-time.

In the present embodiment, the term “process” may indicate a facility or a worker, or an aggregate thereof. It is also possible to assume a factory as one process. Generally, in a manufacturing industry, facilities and workers are prone to be controlled as an aggregate (an organization) for any reason, and therefore, this aggregate may be assumed as the “process”.

In the present embodiment, an explanation will be made, taking as an example a situation where one unit of product “PC” is manufactured by using one unit of interim product “HDD” and one unit of component “CPU”, and the interim product “HDD” is manufactured by using one unit of component “DISK”.

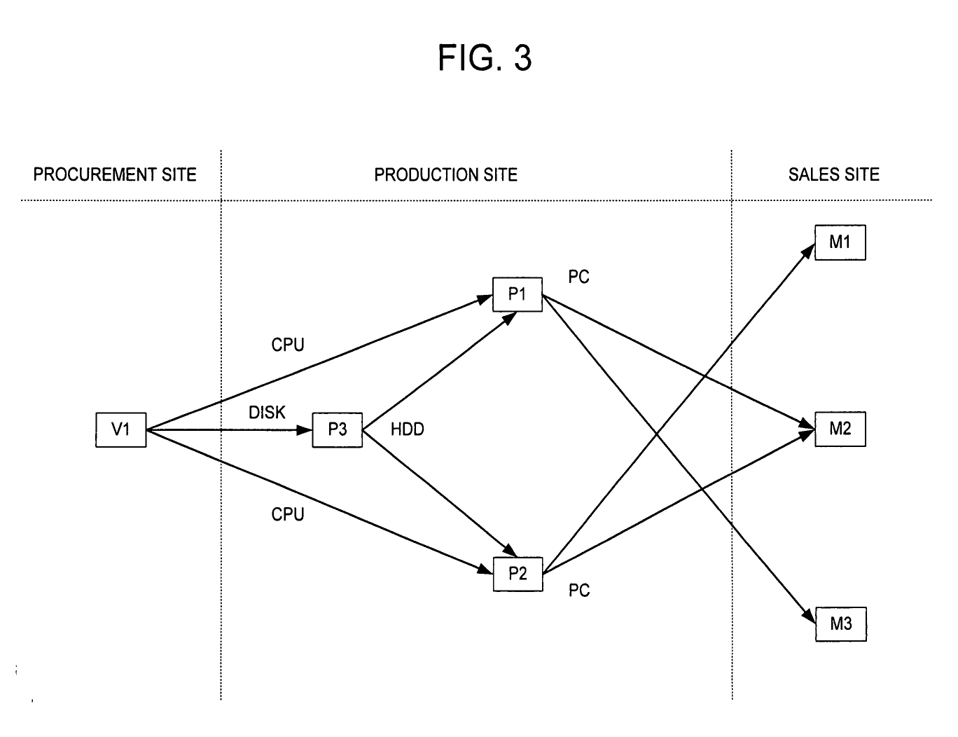

As illustrated in FIG. 3 (a schematic illustration showing the sites), it is assumed that there are three sites M1, M2, and M3 as the sales sites of PC, two sites P1 and P2 as the production sites of PC, one site P3 as the production site of HDD, and one site V1 as a procurement site for procuring CPU and DISK.

Returning to FIG. 1, the supply planning system 100 is provided with storage 110, a controller 120, an input section 130, and an output section 140.

The storage 110 is provided with a sales planning information storage area 111, a supply information storage area 112, a process information storage area 113, a BOM information storage area 114, an inventory information storage area 115, and a warehousing information storage area 116, an evaluation index storage area 117, and a planning information storage area 118.

The sales planning information storage area 111 is an area to store sales planning information including requested period and a requested quantity with respect to each product.

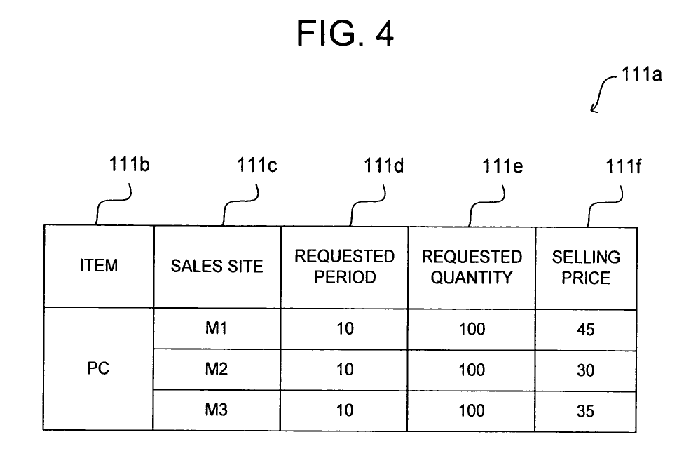

By way of example, in the present embodiment, a sales planning table 111a as shown in FIG. 4 (a schematic illustration of the sales planning table 111a) is stored in the sales planning information storage area 111.

As illustrated, the sales planning table 111a includes; an item column 111b, a sales site column 111c, a requested period column 111d, a requested quantity column 111e, and a selling price column 111f.

In the item column 111b, there is stored identification information (in the example here, a name of product) to identify an item as a sales object.

In the sales site column 111c, there is stored identification information (in the example here, a name of site) to identify a sales site for selling the item (product) specified in the item column 111b.

In the requested period column 111d, there is stored information to specify the requested period when an item (product) specified in the item column 111b is requested. In the present embodiment, planning periods from period 1 to period 10 are predetermined. A period when the product delivery is requested is selected from these periods, and it is stored in this requested period column. However, the present invention is not limited to this configuration. By way of example, it is alternatively possible to store information specifying a date in year, month, and day format when the product delivery is requested.

In the requested quantity column 111e, there is stored information to specify the requested quantity of the item (product) specified in the item column 111b to be delivered in the period specified in the requested period column 111d.

In the selling price column 111f, there is stored information to specify a selling price (price) of the item (product) specified in the item column 111b.

In the supply information storage area 112, there is stored supply information including a supply means between sites, and a supply lead-time.

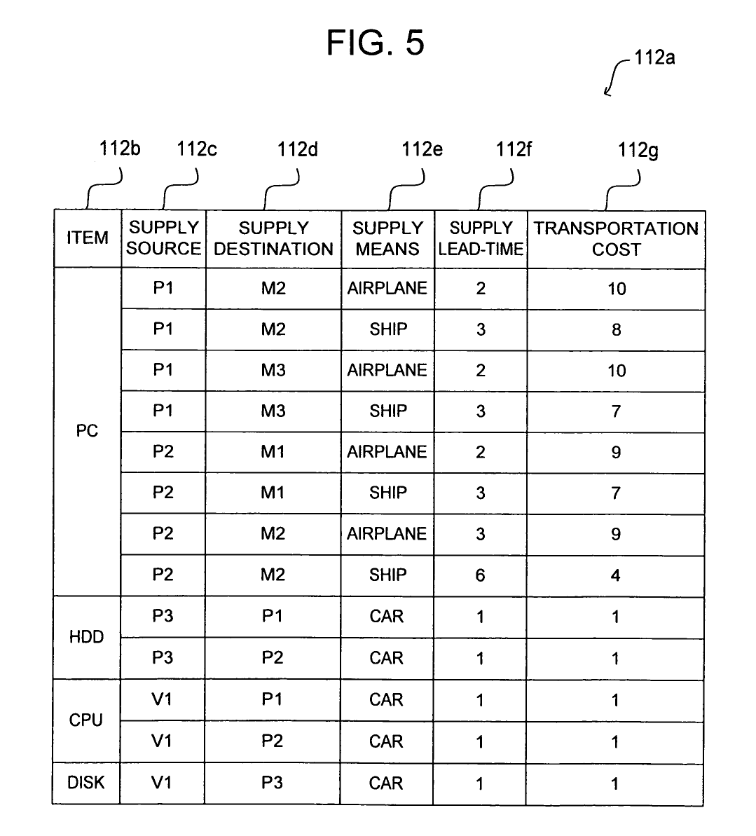

By way of example, in the present embodiment, a supply table 112a as shown in FIG. 5 (a schematic illustration of the supply table 112a) is stored in the supply information storage area 112.

As illustrated, the supply table 112a includes an item column 112b, a supply source column 112c, a supply destination column 112d, a supply means column 112e, a supply lead-time column 112f, and transportation cost column 112g.

In the item column 112b, there is stored identification information (in the example here, a product name or a component name) to specify an item to be traded between the sites.

In the supply source column 112c, there is stored identification information (in the example here, a site name) to identify the site of the supply source to supply the item specified by the item column 112b.

In the supply destination column 112d, there is stored identification information (in the example here, a site name) for identifying the site of the supply destination to which the item specified in the item column 112b is supplied.

In the supply means column 112e, there is stored information to specify the supply means to supply the item specified in the item column 112b from the site specified in the supply source column 112c to the site specified in the supply destination column 112d.

In the supply lead-time column 112f, there is stored information to specify a supply lead-time, when the item specified in the item column 112b is supplied from the site specified in the supply source column 112c to the site specified in the supply destination column 112d.

In the transportation cost column 112g, there is stored information to specify a transportation cost, when the item specified in the item column 112b is supplied from the site specified in the supply source column 112c to the site specified in the supply destination column 112d.

In the process information storage area 113, there is stored process information including a facility to manufacture the product, a time-of-use of the facility, and the production cost.

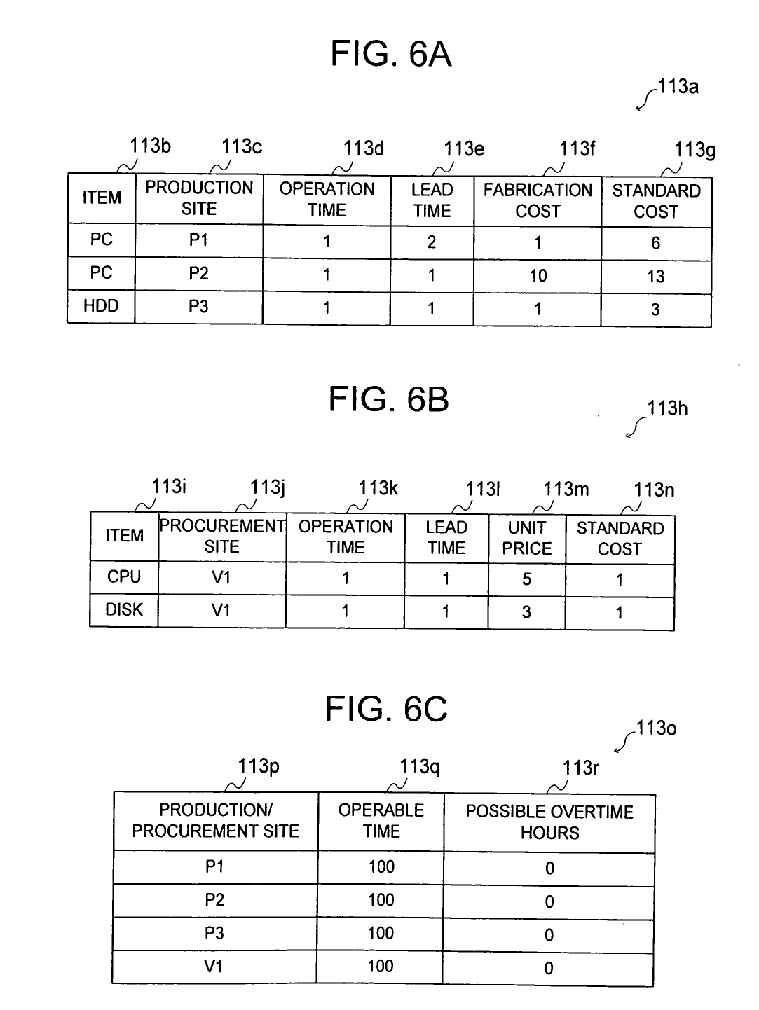

By way of example, in the present embodiment, a first process table 113a shown in FIG. 6A (a schematic illustration of the first process table 113a), a second process table 113h shown in FIG. 6B (a schematic illustration of the second process table 113h), and a time table 113o shown in FIG. 6C (a schematic illustration of the time table 113o) are stored in the process information storage area 113.

As shown in FIG. 6A, the first process table 113a includes an item column 113b, a production site column 113c, an operation time column 113d, a lead-time column 113e, a fabrication cost column 113f, and a standard cost column 113g.

In the item column 113b, there is stored identification information (in the example here, a product name or a component name) to identify an item to be manufactured.

In the production site column 113c, there is stored identification information (in the example here, a site name) to identify the site for manufacturing the item specified in the item column 113b.

In the operation time column 113d, there is stored information to specify an operation time for manufacturing the item specified in the item column 113b at the site specified in the production site column 113c.

In the lead-time column 113e, there is stored information to specify the production lead-time for manufacturing the item specified in the item column 113b at the site specified in the production site column 113c.

In the fabrication cost column 113f, there is stored information to specify a fabrication cost, when the item specified in the item column 113b is manufactured at the site specified in the production site column 113c.

In the standard cost column 113g, there is stored information to specify an average prime cost, when the item specified in the item column 113b is manufactured at the site specified in the production site column 113c. It is to be noted that this standard cost is used for calculating the inventory cost and the like.

As shown in FIG. 6B, the second process table 113h includes an item column 113i, a procurement site column 113j, an operation time column 113k, a lead-time column 113l, a unit price column 113m, and a standard cost column 113n.

In the item column 113i, there is stored information to specify identification information (in the example here, a product name or a component name) to identify an item to be manufactured.

In the procurement site column 113j, there is stored information to specify identification information (in the example here, a site name) to identify a site of a procurement source for procuring the item that is specified in the item column 113i.

In the operation time column 113k, there is stored information to specify the operation time to procure the item specified in the item column 113i from the site specified in the procurement site column 113j.

In the lead-time column 113l, there is stored information to specify the procurement lead-time to procure the item specified in the item column 113i from the site specified in the procurement site column 113j.

In the unit price column 113m, there is stored information to specify the unit price, when the item specified in the item column 113i is procured from the site specified in the procurement site column 113j.

In the standard cost column 113n, there is stored information to specify an average prime cost when the item specified in the item column 113i is procured from the site specified in the procurement site 113j. It is to be noted that the standard cost is used for calculating the inventory cost and the like.

As shown in FIG. 6C, the time table 113c includes a production/procurement site column 113p, an operable time column 113q, and a possible overtime hours 113r.

In the production/procurement site column 113p, there is stored information to specify identification information (in the example here, a site name) to identify a site for production or a site for procurement.

In the operable time column 113q, there is stored information to specify the operable time at the site specified in the production/procurement site column 113p.

In the possible overtime hours column 113r, there is stored information to specify the possible overtime hours at the site specified in the production/procurement column 113p.

In the BOM (Bill of Materials) information storage area 114, there is stored BOM information which includes information to specify the components constituting the product, and information to specify the production lead-time when the product is manufactured, with respect to each product. By way of example, in the present embodiment, it is assumed that one unit of product “PC” is manufactured by using one unit of interim product “HDD” and one unit of component “CPU”, and the interim product “HDD” is manufactured by using one unit of component “DISK”.

In the inventory information storage area 115, there is stored inventory information including inventory quantities with respect to each item (product or component). Here, in the present embodiment, an initial inventory (inventory in the end of period zero) is assumed as “0”.

In the warehousing information storage area 116, there is stored warehousing information including an available timing and a quantity of the items which become usable by procurement, with respect to each item. Here in the present embodiment, the initial warehousing schedule (a warehousing schedule at the end of the period zero) is assumed as “0”.

In the evaluation index storage area 117, there are stored calculating formulas of evaluation indexes to evaluate the supply plan, priority information including the evaluation indexes, and priorities of the evaluation indexes, and a constraint condition.

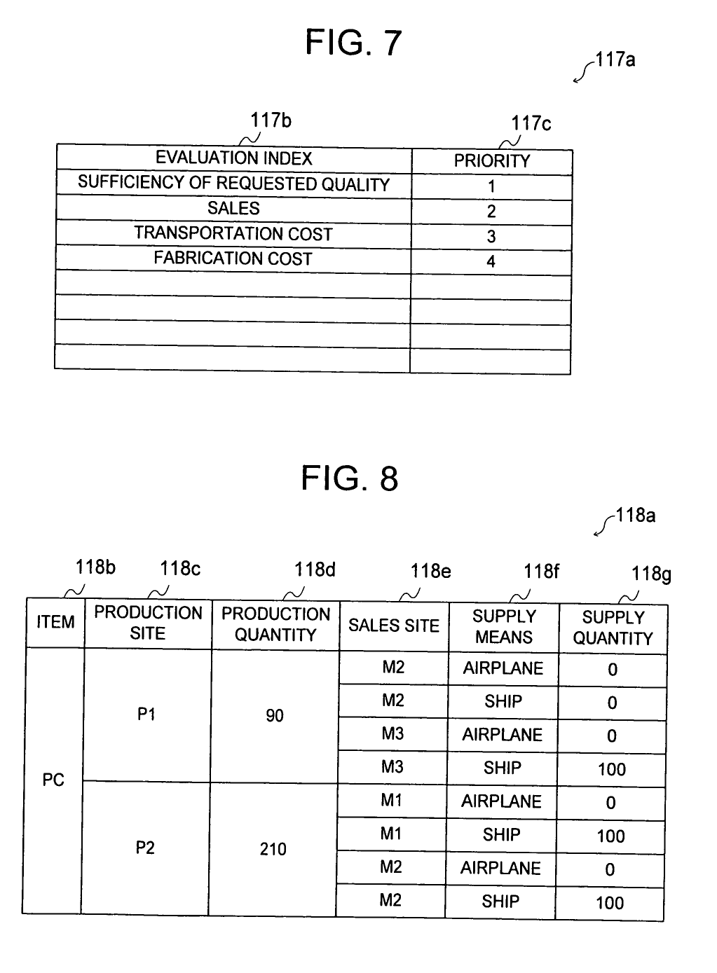

By way of example, in the present embodiment, a priority table 117a as shown in FIG. 7 (a schematic illustration of the priority table 117a) is stored in the evaluation index storage area 117.

As illustrated, the priority table 117a includes an evaluation index column 117b and a priority column 117c.

In the evaluation index column 117b, there is stored information to specify identification information (in the example here, an evaluation index name) to identify the evaluation index.

In the priority column 117c, there is stored information to specify the priority of the evaluation index specified in the evaluation index column 117b. Here in the present embodiment, the priority is specified in such a manner as serially numbered from “1”, from the evaluation index having the highest priority.

It is to be noted that in the present embodiment, four indexes are used as the evaluation indexes; a sufficiency of the requested quantity, a sales, a transportation cost, and a fabrication cost. However, the evaluation indexes are not limited to those four indexes.

Here, in the present embodiment, a formula to calculate the evaluation index indicating the sufficiency of the requested quantity is specified as the following formula (1), but it is not limited to this example:

$$\begin{matrix}[ FORMULA 1 ] & \\ {\sum }_{i}^{ } {\sum }_{q}^{ } {\sum }_{t}^{ } \{ {D}_{i , q , t} - {X}_{i , q , t} \} & ( 1 )\end{matrix}$$

Here, “i” represents an identifier to identify an item, “q” represents an identifier to identify a sales site, and “t” represents an identifier to identify a period being predetermined. “D” represents a requested quantity, and D_{i,q,t} represents a requested quantity of the item “i”, at the sales site “q” in the period “t”. In addition, “X” represents a sales quantity, and Xi,q,t represents a sales quantity of the item “i”, at the sales site “q” in the period “t”.

In the present embodiment, a formula to calculate the evaluation index indicating the sales is specified as the following formula (2), but it is not limited to this example:

$$\begin{matrix}[ FORMULA 2 ] & \\ - {\sum }_{i}^{ } {\sum }_{q}^{ } \{ {PR}_{i , q} \cdot {\sum }_{t}^{ } {X}_{i , q , t} \} & ( 2 )\end{matrix}$$

Here, “PR” represents a price and “PR_{i,q}” represents a prices (selling price) of the item “i” at the sales site “q”. It is to be noted that the formula (2) has the sign “−(minus)”, because the formula is to calculate an optimum value of the sales as a minimum value, similar to the other evaluation indexes.

In the present embodiment, a formula to calculate the evaluation index indicating the transportation cost is specified as the following formula (3), but it is not limited to this example:

$$\begin{matrix}[ FORMULA 3 ] & \\ {\sum }_{i}^{ } {\sum }_{p}^{ } {\sum }_{q}^{ } {\sum }_{e}^{ } \{ {Q}_{i , p , q , e} \cdot {\sum }_{t}^{ } {U}_{i , p , q , e , t} \} & ( 3 )\end{matrix}$$

In here, “p” represents an identifier to identify a production site, and “e” represents an identifier to identify a supply means. “Q” represents a transportation cost, and “Q_{i,p,q,e}” represents a transportation cost when the item “i” is transported from the production site “p” to the sales site “q” by using the supply means “e”. “U” represents a shipped quantity, “U_{i,p,q,e,t}” represents the shipped quantity to transport the item “i” from the production site “p” to the sales site “q” by using the supply means “e” in the period “t”.

In the present embodiment, a formula to calculate the evaluation index indicating the fabrication cost is specified as the following formula (4), but it is not limited to this example:

$$\begin{matrix}[ FORMULA 4 ] & \\ {\sum }_{i}^{ } {\sum }_{p}^{ } \{ {PP}_{i , p} \cdot {\sum }_{t}^{ } {R}_{i , p , t} \} & ( 4 )\end{matrix}$$

Here, “PP” represents a production cost, “PP_{i,p}” represents the production cost of the item “i” at the production site “p”. “R” represents a warehousing quantity, and “R_{i,p,t}” represents the warehousing quantity of the item “i” at the production site “p” in the period “t”.

It is to be noted that the calculating formulas of the evaluation indexes specified in the formulas (1) to (4) are also associated with the respective names of the evaluation indexes and stored in the evaluation index storage area 117.

In the present embodiment, four constraint conditions are employed; a supply lead-time constraint, an inventory carrying-over constraint at the production site, a production capacity constraint, an inventory carrying-over constraint at the sales site. However, the constraint conditions are not limited to those conditions as described above.

Here in the present embodiment, the supply lead-time constraint is specified by the following formula (5), but it is not limited to this example:

$$\begin{matrix}[ FORMULA 5 ] & \\ {\sum }_{p}^{ } {\sum }_{e}^{ } {U}_{i , p , q , e , t - {DLT}_{i , p , q , e}} = {R}_{i , q , t} & ( 5 )\end{matrix}$$

Here, “DLT” represents a supply lead-time, “DLT_{i,p,q,e}” represents the supply lead-times when the item “i” is supplied from the production site “p” to the sales site “q” by the supply means “e”.

In addition, “U_{i,p,p,e,t-DLTi,p,q,e}” represents a shipped quantity of the item “i” from the production site “p” to the sales site “q” by the supply means “e”, after the lapse of the supply lead-time “DLT_{i,p,q,e}” in the period “t”.

Next, in the present embodiment, the inventory carrying-over constraint is specified by the following formula (6), but it is not limited to this example:

[FORMULA 6]

I_{i,p,t}=I_{i,p,t-1}+R_{i,p,t}−ΣΣU_{i,p,q,e,t} (6)

Here, “I” represents an inventory quantity, and “I_{i,p,t}” represents the inventory quantity of the item “i” at the production site “p” in the period “t”.

Next, the production capability constraint in the present embodiment is specified by the following formula (7), but it is not limited to this example:

$$\begin{matrix}[ FORMULA 7 ] & \\ {\sum }_{i}^{ } {K}_{i , p} \cdot {R}_{i , p , t} ≦ {C}_{p , t} & ( 7 )\end{matrix}$$

Here, “K” represents an operation time per unit, and “K_{i,p}” represents the operation time per unit, of the item “i” at the production site “p”.

In addition, “C” represents an operable time, and “C_{p,t}” represents the operable time in the period “t” at the production site “p”.

Next in the present embodiment, the inventory carrying-over constraint at the sales site is specified by the following formula (8), but it is not limited to this example:

[FORMULA 8]

I_{i,q,t}=I_{i,q,t-1}+R_{i,q,t}−X_{i,q,t} (8)

The constraint conditions specified by the described formulas (5) to (8) are also stored in the evaluation index storage area 117.

The planning information storage area 118 stores 20 information to specify a supply plan.

By way of example, in the present embodiment, as shown in FIG. 8 (a schematic illustration of the supply plan table 118a), the supply plan table 118a is stored in the planning information storage area 118.

As illustrated, the supply plan table 118a includes, an item column 118b, a production site column 118c, a production quantity column 118d, a sales site column 118e, a supply means column 118f, and a supply quantity column 118g.

In the item column 118b, there is stored information to specify identification information (in the example here, a product name) to identify an item to be supplied.

In the production site column 118c, there is stored identification information (in the example here, a site name) to identify a site where the item (product) specified by the item column 118b is manufactured (shipped).

In the production quantity column 118d, there is stored information to specify a production quantity of the item (a product) specified in the item column 118b which is manufactured at the site specified in the production site column 118c.

In the sales site column 118e, there is stored information to specify identification information (in the example here, a site name) to identify a site to sell the item (product) specified in the item column 118b.

In the supply means column 118f, there is stored information to specify the supply means to supply (to transport) the item (product) specified in the item column 118b from the site specified at the production site column 118c to the site specified in the sale site column 118e.

In the supply quantity column 118g, there is stored information to specify the supply quantity of the item (product) specified in the item column 118b, to be supplied from the site specified in the production site column 118c to the site specified in the sales site column 118e.

The controller 120 is provided with a supply model generator 121, an evaluation formula generator 122, a calculation processor 123, and a plan output section 124.

The supply model generator 121 refers to the sales planning information as a basis, which is stored in the sales planning information storage area 111 of the storage 111, uses as variables, a completed quantity per period of the product at the production site, a shipped quantity and arrived quantity per period with respect to each supply means from the production site to the sales site, to generate a formula of constraint condition by using the supply information, the process information, the evaluation index information, and if necessary, component information, inventory information, and warehousing schedule information as well. It is to be noted that the method itself for generating the formula of the constraint condition is a publicly known technique, and a detailed explanation will not be made.

The evaluation formula generator 122 generates an evaluation formula the number of which is equal to less than the number of the evaluation indexes, based on the evaluation indexes and their priorities.

The calculation processor 123 uses the constraint condition formula generated in the supply model generator 121 and the evaluation formula generated in the evaluation formula generator 122, thereby calculating variable values.

The plan output section 124 calculates a completed quantity (production quantity) per period of the product, and a shipped quantity (supply quantity) per period from the production site to the sales site, with respect to each supply means, thereby generating a supply plan and stores the supply plan in the planning information storage area 118.

The input section 130 accepts inputting of information.

The output section 140 outputs information.

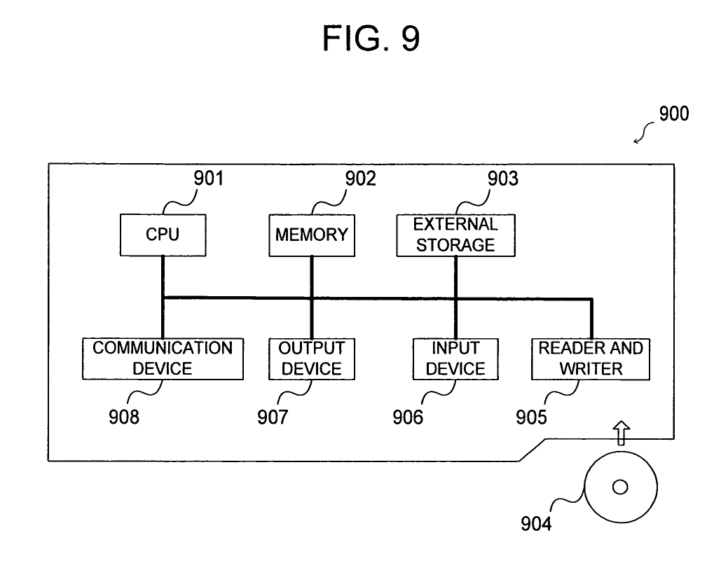

The supply planning system 100 as described above may be implemented, as shown in FIG. 9 (a schematic illustration of the computer 900), incorporates a CPU (Central Processing Unit) 901, a memory 902, an external storage device 903 such as an HDD (Hard Disk Drive), a reader and writer 905 for reading and writing information to a storage medium 904 with a movability, such as CD-ROM (Compact Disk Read Only Memory) and DVD-ROM (Digital Versatile Disk Read Only Memory), an input device 906 such as a keyboard and a mouse, an output device 907 such as a display, and a communication device 908 such as an NIC (Network Interface Card) to be connected with a communication network.

By way of example, the storage 110 can be implemented when the CPU 901 makes use of the memory 902 or the external storage device 903, the controller 120 can be implemented when a predetermined program stored in the external storage device 903 is loaded on the memory 902 and executed by the CPU 901, the input section 130 can be implemented when the CPU 901 makes use of the input device 906, and the output section 140 can be implemented when the CPU 901 makes use of the output device 907.

This predetermined program may be downloaded on the external storage device 903 from the storage medium 904 via the reader and writer 905, or from the network via the communication device 908, and then, the program is loaded on the memory 902 and executed by the CPU 901. Alternatively, this predetermined program may be downloaded directly on the memory 902 from the storage medium 904 via the reader and writer 905, or from the network via the communication device 908, and executed by the CPU 901.

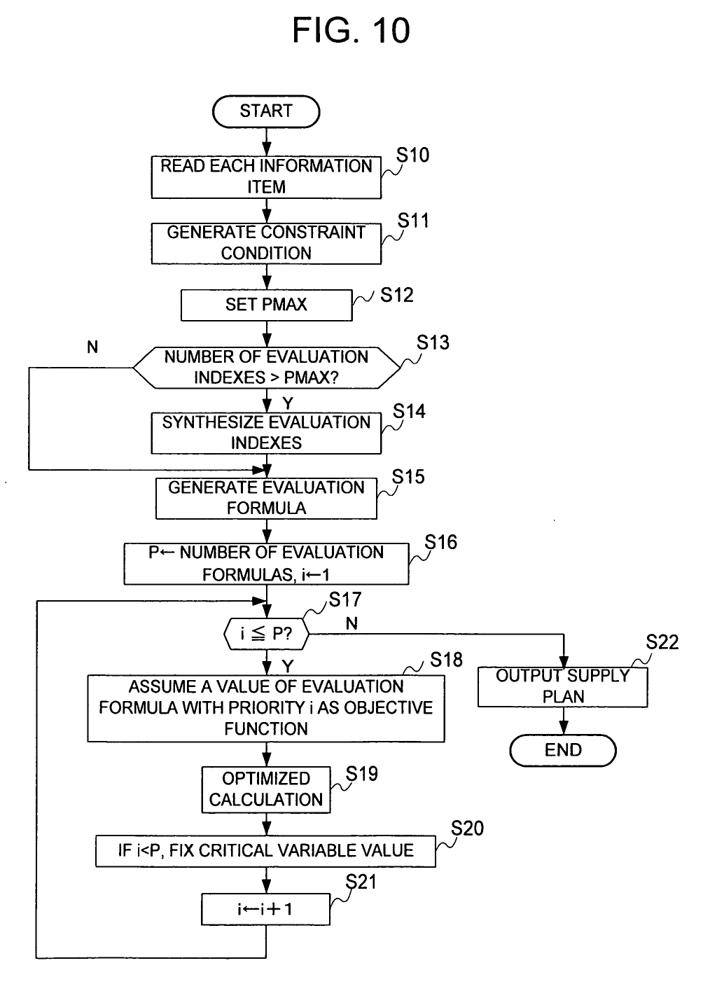

FIG. 10 is a flowchart showing a processing to establish a supply plan in the supply planning system 100.

Firstly, the supply model generator 121 acquires from the storage 110, the sales planning information stored in the sales planning information storage area 111, the supply information stored in the supply information storage area 112, the process information stored in the process information storage area 113, the BOM information stored in the BOM information storage area 114, the inventory information stored in the inventory information storage area 115, the warehousing information stored in the warehousing information storage area 116, the priority information, the evaluation index, and the constraint condition stored in the evaluation index storage area 117 (S10).

Next, the supply model generator 121 describes the constraint condition in the form of a linear equation (S11). In the present embodiment, each of the constraint conditions specified in the aforementioned formulas (5) to (8) is described in the linear equation.

Next, the evaluation formula generator 122 sets a value of PMAX (S12). PMAX represents a threshold value indicating a maximum number of the evaluation formulas generated in step S15 described below. In the present embodiment, the value of PMAX is assumed as a predetermined fixed value.

Next, the evaluation formula generator 122 specifies the number of the evaluation indexes (a maximum number of priorities) based on the priority information which specifies the evaluation indexes and the priorities thereof, and compares the number with the value of PMAX set in step 12 (S13). Then, when the number of the evaluation indexes is larger than the value of PMAX, the processing proceeds with step S14, and when the number of the evaluation indexes is equal to or smaller than the value of PMAX, the processing proceeds with step S15.

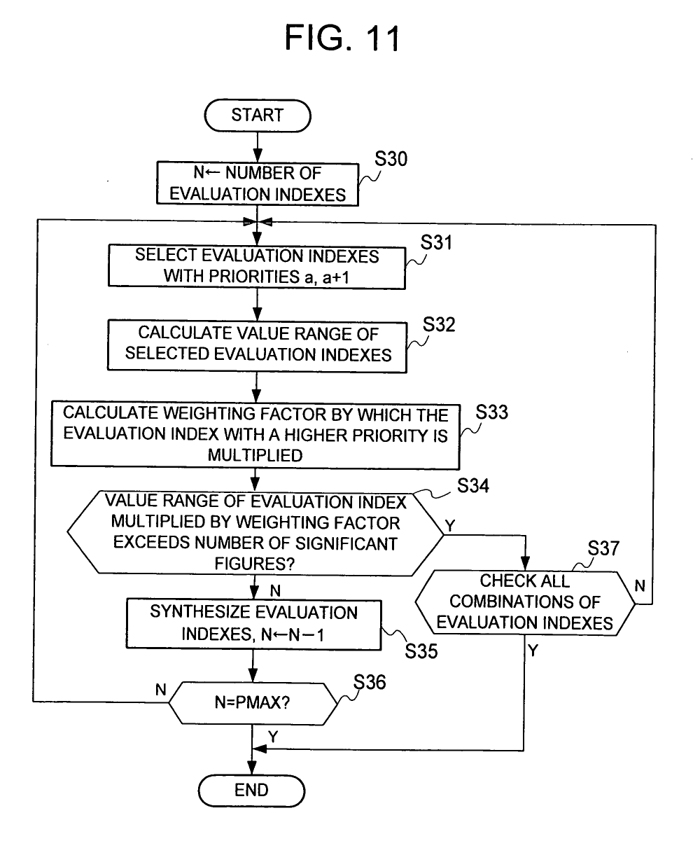

In step S14, the evaluation formula generator 122 performs a processing for synthesizing the evaluation indexes, thereby making the number of evaluation indexes to be equal or less than the value of PMAX. It is to be noted that the processing for synthesizing the evaluation indexes will be explained in detail with reference to FIG. 11.

Next, the evaluation formula generator 122 generates an evaluation formula (S15). Here, in the case where the evaluation indexes are specified as synthetic objects in the step S14, the evaluation indexes as the synthetic objects are expressed in the form of a formula using factors.

By way of example, according to the synthetic processing in the step S14, the calculation formula f(a) of the evaluation index in the priority a (“a” is a natural number at least one), and the calculation formula f(a+1) of the evaluation index in the priority (a+1) are synthesized, so as to obtain an evaluation index having the priority i (“i” is a natural number at least one, and 1≦i≦PMAX). Then, the evaluation formula z(i) is expressed as the following formula (9)

[FORMULA 9]

z(i)=wf(a)+f(a+1) (9)

Here, “w” represents a weighting factor obtained in FIG. 11 as described below.

By way of example, the following formula (10) is an example where the evaluation index calculation formula of the transportation cost and the evaluation index calculation formula of the production cost are synthesized:

$$\begin{matrix}[ FORMULA 10 ] & \\ w {\sum }_{i}^{ } {\sum }_{p}^{ } {\sum }_{q}^{ } {\sum }_{e}^{ } \{ {Q}_{i , p , q , e} \cdot {\sum }_{t}^{ } {U}_{i , p , q , e , t} \} + {\sum }_{i}^{ } {\sum }_{p}^{ } \{ {PP}_{i , p} \cdot {\sum }_{t}^{ } {R}_{i , p , t} \} & ( 10 )\end{matrix}$$

In addition, the following formula (11) is an example where the evaluation index calculation formula of the sufficiency of the requested quantity, and the evaluation index calculation formula of the sales:

$$\begin{matrix}[ FORMULA 11 ] & \\ w {\sum }_{i}^{ } {\sum }_{q}^{ } {\sum }_{t}^{ } \{ {D}_{i , q , t} - {X}_{i , q , t} \} - {\sum }_{i}^{ } {\sum }_{q}^{ } \{ {PR}_{i , q} \cdot {\sum }_{t}^{ } {X}_{i , q , t} \} & ( 11 )\end{matrix}$$

On the other hand, as for the evaluation index which is not assigned as a synthetic object according to the synthetic processing in the step S14, the evaluation index calculation formula, as it is, is used as the evaluation formula.

Furthermore, the evaluation formula generator 122 defines a variable which stores a value of the evaluation formula z(i), and adds the variable to the model as the constraint condition.

Next, the calculation processor 123 stores the number of evaluation formulas as the maximum number P of the evaluation formulas to which optimization is applied, and initializes the priority index “i” to “1” (S16).

The calculation processor 123 determines whether or not i≦P (S17), and if i≦P, the processing proceeds with step S18, whereas if “i” is not in the range of i≦P, the processing proceeds with step S22.

In step S18, the calculation processor 123 specifies a value of the evaluation formula with the priority i, as an objective function.

Next, the calculation processor 123 applies an optimized calculation to the variable y storing the value of the evaluation formula z(i) with the priority i, using a factor of the objective function being a value other than zero (S19). As for the value of the factor of the objective function, a positive value is used (“1” is recommended), if the variable y is to be minimized, and a negative value is used (“−1” is recommended), if the variable y is to be maximized.

It is to be noted that the optimized calculation is performed by an engine (referred to as linear programming engine) to solve the linear programming incorporated in the calculation processor 123. Since the operation of the linear programming engine is publicly known, an explanation thereof will not be made. As a result of the optimized calculation, there are obtained an optimum value of the evaluation formula, and solutions of each of the variables.

Next, as a result of the optimized calculation, if i<P, the calculation processor 123 fixes the current solution as a critical variable value for the optimum value (S20). The critical value indicates a variable that makes the optimum value worse, if the value is moved from the current solution. Specifically, a variable whose reduced cost value is not zero may correspond to the critical variable, which is held by the linear programming engine during the calculation.

Then, the calculation processor 123 increments “i” by “1” (S21), and the processing returns to the step S17.

On the other hand, in step S22, the plan output section 124 establishes a supply plan by using each of the variable values solved at the P-th time, and stores the supply plan in the planning information storage area 118.

It is to be noted that the supply plan established by the plan output section 124 may be displayed by the output section 140 or the like. Alternatively, it may be outputted as electronic data for other system.

FIG. 11 is a flowchart showing a synthetic processing of the evaluation indexes.

Firstly, the evaluation formula generator 122 stores the number of the evaluation indexes in the variable N (S30).

Next, the evaluation formula generator 122 selects evaluation indexes respectively with the priority “a” and with the priority “a+1” (“a” is a natural number at least one), according to a predetermined rule (S31).

By way of example, it is preferable that the evaluation formula generator 122 makes a combination (pair) of two evaluation indexes in accordance with the priority sequentially from the lowest one, and the combination (pair) with the lower priority is sequentially selected in step S31. It is desirable, for instance, to make a selection according to the rule as the following; in the case where there are evaluation indexes having the priorities from 1 to 8, firstly, the evaluation indexes having the priorities “7” and “8” are selected in the step S31. In the next loop, the evaluation indexes having the priorities “5” and “6” are selected in the step S31. Further in the next loop, the evaluation indexes having the priorities “3” and “4” are selected in the step S31.

It is further possible to set the rule as the following; in the case where there are evaluation indexes having the priorities from 1 to 8, firstly, the evaluation indexes having the priorities “7” and “8” are selected in the step S31. In the next loop, the evaluation index synthesized in the step S35 described below, and the evaluation index having the priority “6” are selected (in the case of exceeding the number of significant figures in the step S34, an evaluation index having next higher priority is selected sequentially. According to this concept, the evaluation index having priority “5” is selected). In the next loop, the evaluation index synthesized in the step S35 described below, and the evaluation index having the priority “5” are selected (in the case of exceeding the number of significant figures in the step S34, an evaluation index having next higher priority is selected sequentially. According to this concept, the evaluation index having priority “4” is selected)

Here, in step S31, it is assumed that the evaluation index f(a) with the priority “a” and the evaluation index f(a+1) with the priority “a+1” are selected.

Next, the evaluation formula generator 122 obtains a value range of each of the evaluation indexes f(a) and f(a+1) which are selected in the step S31 (S32). Specifically, the value ranges of the evaluation indexes f(a) and f(a+1) are calculated from the value ranges of the variables used for calculating the evaluation indexes.

Next, the evaluation formula generator 122 calculates a weighting factor of the evaluation index f(a) with a higher priority (S33).

If the evaluation formula is directed to minimization, the weighting factor adjusts the assignment of weights so that a decreasing degree per unit of f(a) is constantly larger than the decreasing degree of f(a+1), and if the evaluation formula is directed to maximization, the weighting factor adjusts the assignment of weights so that an increasing degree per unit of f(a) is constantly larger than the increasing degree of f(a+1). With the configuration above, even if there is a tradeoff relationship (when one value is made smaller the other value becomes larger) between f(a+1) and f(a), when f(a) is made smaller than f(a+1) in minimization, the objective function can be made smaller. On the other hand, when f(a) is made larger than f(a+1) in maximization, the objective function can be made larger. Therefore, f(a) can be prioritized in any case.

By way of example, if the value range of f(a+1) is from 1[a+1] to u[a+1], the decreasing degree (or increasing degree) is |u[a+1]−1[a+1] (=absolute value) at the maximum. Therefore, the weighting factor w of f(a) is set to be a value larger than |u[a+1]−1[a+1]| by adding any number, for example, |u[a+1]−1[a+1]|+1.

Here in the example, “1” is added to obtain the value larger by any number. However, the present embodiment is not limited to this example. It is also possible to select any number (a natural number), in accordance with to the value ranges of f(a) and f(a+1).

Next, the evaluation formula generator 122 checks whether or not the value range (from w×1[a] to w×u[a]) obtained by multiplying the evaluation index f(a) by the weighting factor calculated in the step S33 exceeds the number of significant figures predetermined in the supply planning system 100 (S34)

If the value range does not exceed the number of significant figures, the processing proceeds with the step S35, and if it exceeds the number of significant figures, the processing proceeds with the step S37.

In the step S35, the evaluation formula generator 122 specifies the evaluation indexes selected in the step S31 as synthetic objects, and subtracts “1” from the evaluation index number N.

Here, the evaluation formula generator 122 assumes as “a”, the priority of the evaluation indexes f(a) and f(a+1) being the synthetic objects, and moves up by one, the priorities of the evaluation index (a+2) and subsequent indexes.

Then, the evaluation formula generator 122 checks whether or not the evaluation index number N matches the PMAX (S36). If there is a match, the evaluation formula generator 122 terminates the processing. If there is not a match, it returns to the step S31 to repeat the processing.

On the other hand, in the step S37, the evaluation formula generator 122 determines whether or not the checking from the steps S32 to 34 has been carried out as to all the combinations of the evaluation indexes specified in the step S31. If all the checking has not been carried out yet, the processing is returned to step S31. If all the checking has been done, the processing is terminated.

If it is determined in the step S37 that the checking has been carried out as to all the combinations of the evaluation indexes, the evaluation formula generator 122 may output information to notify an error on the output section 140, and terminate the processing shown in FIG. 10.

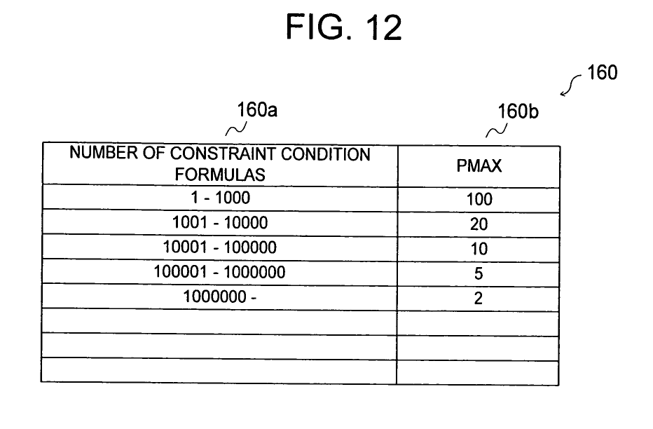

In the present embodiment as described above, a value of PMAX is assumed as a fixed value being predetermined in the step S12 in FIG. 10. However, the present embodiment is not limited to this example. For instance, it is further possible that a PMAX setting information table 160 as shown in FIG. 12 (a schematic illustration of the PMAX setting information table 160) is stored in the storage 110, and the evaluation formula generator 122 acquires and sets a value of PMAX being associated to the number of the constraint condition formulas.

It is to be noted, as illustrated, that the PMAX setting table 160 includes a constraint condition formula number column 160a and a PMAX column 160b.

In the constraint condition formula number column 160a, there is stored information to specify the range of the number of the constraint conditions, and the PMAX column 160b stores a value of PMAX in association with the range of the constraint condition formula number.

As for the setting of the value of PMAX, it is possible to configure such that an operator of the supply planning system 100 performs the setting via the input section 130, based on a processing capacity of the computer to be used, a calculation time which is allowed to be used by the supply planning system 100, and a numerical value experiment calculated from the information stored in the storage 110.

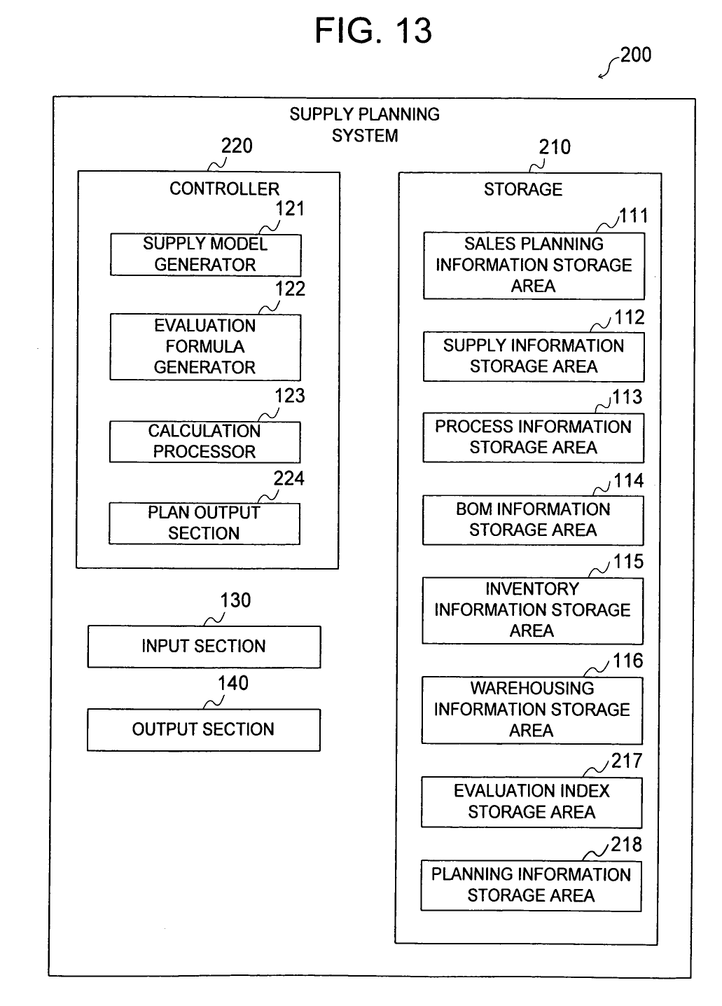

FIG. 13 is a schematic illustration of the supply planning system 200 according to a second embodiment of the present invention.

As illustrated, the supply planning system 200 is provided with storage 210, a controller 220, an input section 130, and an output section 140. If compared with the first embodiment, there are differences in the storage 210 and the controller 220. Therefore, hereinafter, the points relevant to these differences will be explained.

The storage 210 is provided with the sales planning information storage area 111, the supply information storage area 112, the process information storage area 113, the BOM information storage area 114, the inventory information storage area 115, the warehousing information storage area 116, an evaluation index storage area 217, and a planning information storage area 218. If compared with the first embodiment, there are differences in the evaluation index storage area 217 and the planning information storage area 218. Therefore, hereinafter, the points relevant to these differences will be explained.

In the evaluation index storage area 217, there are stored evaluation indexes for evaluating the supply plan, priority information having the evaluation indexes and the priorities of the evaluation indexes, and the constraint condition.

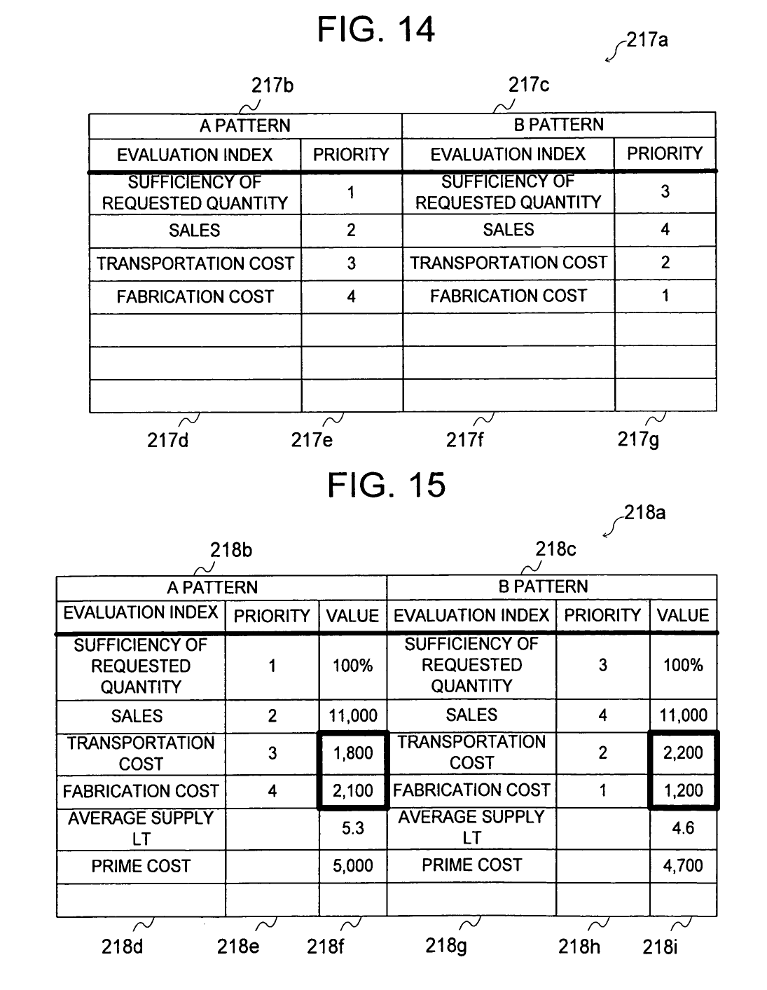

Here in the present embodiment, there is stored as priority information, a priority table 217a as shown in FIG. 14 (a schematic illustration of the priority table 217a) in the evaluation index storage area 217.

As illustrated, the priority table 217a includes an A pattern column 217b and a B pattern column 217c. The A pattern column 217b includes an evaluation index column 217d and a priority column 217e. The B pattern column 217c includes an evaluation index column 217f and a priority column 217g.

It is to be noted that the information items stored in the evaluation index columns 217d and 217f, and the priority columns 217e and 217g are the same as the first embodiment, and explanations thereof will not be made tediously.

As thus described, in the present embodiment, it is configured such that the priorities of the evaluation indexes can be specified by using various patterns. Here in this example, two patterns A and B are prepared as the priorities of the evaluation indexes, but any number can be set as for the number of the patterns.

The planning information storage area 218 stores the information for specifying the supply plan.

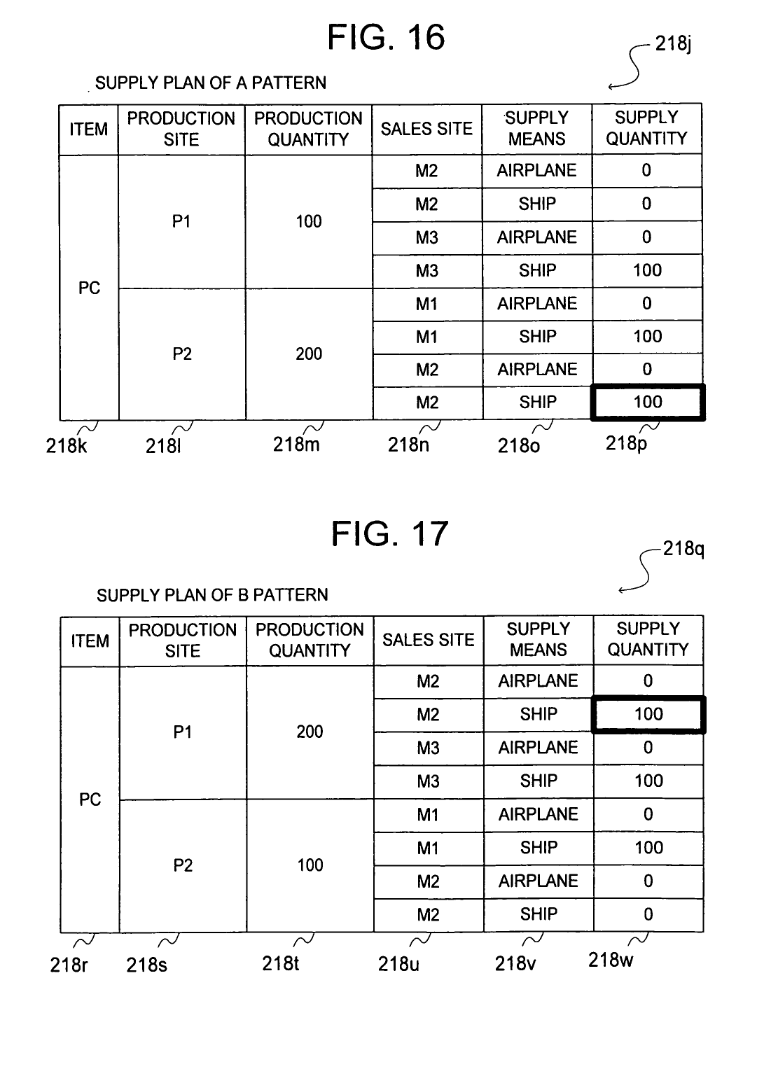

Here, in the present embodiment, there are stored in the planning information storage area 218, a comparison table 218a as shown in FIG. 15 (a schematic illustration of the comparison table 218a), a first supply plan table 218j as shown in FIG. 16 (a schematic illustration of the first supply plan table 218j ), and a second supply plan table 218q as shown in FIG. 17 (a schematic illustration of the second supply plan table 218q).

As shown in FIG. 15, the comparison table 218a includes an A pattern column 218b and a B pattern column 218c. The A pattern column 218b includes an evaluation index column 218d, a priority column 218e, and a value column 218f. The B pattern column 218c includes an evaluation index column 218g, a priority column 218h, and a value column 218i.

Here, in the evaluation index column 218d, in the priority column 218e, and in the value column 218f in the A pattern column 218b, there are stored the evaluation indexes and the priorities specified in the A pattern column 217b in the aforementioned priority table 217a, and values calculated based on the evaluation indexes and the priorities. In the evaluation index column 218g, in the priority column 218h, and in the value column 218i in the B pattern column 218c, there are stored the evaluation indexes and the priorities specified in the B pattern column 217c in the aforementioned priority table 217a, and values calculated based on the evaluation indexes and the priorities.

As shown in FIG. 16, the first supply plan table 218j includes an item column 218k, a production site column 218l, a production quantity column 218m, a sales site column 218n, a supply means column 218o, and a supply quantity 218p. The information stored in those columns is information of the supply plan which is calculated based on the evaluation indexes and the priorities specified in the aforementioned A pattern column 217b of the priority table 217a. It is to be noted that the information stored in each of the columns is the same as that of the first embodiment, and an explanation will not be made tediously.

As shown in FIG. 17, the second supply plan table 218q includes an item column 218r, a production site column 218s, a production quantity column 218t, a sales site column 218u, a supply means column 218u, and a supply quantity column 218w. The information stored in those columns is information of the supply plan which is calculated based on the evaluation indexes and the priorities specified by the aforementioned B pattern column 217c of the priority table 217a. It is to be noted that the information stored in each of the columns is the same as that of the first embodiment, and an explanation will not be made tediously.

The controller 220 is provided with the supply model generator 121, the evaluation formula generator 122, the calculation processor 123, and a plan output section 224. If compared with the first embodiment, there is a difference in the plan output section 224, and therefore, a point relevant to the difference will be explained in the following.

It is to be noted that the supply model generator 121, the evaluation formula generator 122, and the calculation processor 123 carry out a processing being the same as those of the first embodiment based on the evaluation indexes and the priorities in each of the patterns in the priority table 217a, and then a result of the processing is outputted to the plan output section 224.

The plan output section 224 integrates the values of the evaluation indexes in each of the patterns calculated by the calculation processor 123, with respect to each combination of the evaluation indexes and the priorities in the respective patterns specified in the priority table 217a. Accordingly, the plan output section 224 generates the comparison table 218a as shown in FIG. 15 and stores the table in the planning information storage area 218.

The plan output section 224 calculates a production quantity (completed quantity) of the product by period at the production site, and the shipped amount (supply quantity) by supply means from the production site to the sales site, based on the variable values calculated by the calculation processor 123, with respect to each combination of the evaluation indexes and the priorities in each of the patterns specified in the priority table 217a, establishes a supply plan, and stores the supply plan in the planning information storage area 218.

It is to be noted that the plan output section 224 performs outputting such as displaying on the output section 140, the comparison table 218a, the first supply plan table 218j, and the second supply plan table 218q stored in the planning information storage area 218, organized in a predetermined format in response to a directive from the operator of the supply planning system 100. As for the predetermined format, it may be any table format as shown in FIG. 15 to FIG. 17, or a graphical format such as a graph and a radar chart.

As described above, according to the second embodiment, the operator or the like of the supply planning system 200 is allowed to select at least one supply plan from the supply plans established in multiple patterns according to the results as described above.

It is preferable that the supply plan selected by the operator or the like is stored in the planning information storage area 118, together with an identifier notifying that it is selected, by inputting via the input section 130 a directive indicating that the selection is made by the operator or the like.

In the present embodiment as described above, inputting of associations between the evaluation indexes and the priorities is accepted via the input section, for example, and it is stored in the evaluation index storage areas 117 and 217. Accordingly, it is possible to easily acquire an evaluation result, according to the priorities desired by the operator of the supply planning system 100 or 200.

It is to be noted that as for the associations between the evaluation indexes and the priorities, at least any either one of the evaluation indexes and the evaluation index names respectively associated with the evaluation indexes, which are stored in the evaluation index storage areas 117 and 217, is displayed on the output section 140. It is further possible to configure such that at least either one of the evaluation indexes and the evaluation index names being displayed is allowed to accept an input of priority assignment via the input section 130.

In the embodiment as described above, it is configured such that the processing is performed in the supply planning system 100 or 200. However, it is further possible that the processing performed in the supply planning system 100 or 200 is executed in other system via the network, or other system is allowed to acquire information stored in the supply planning system 100 or 200. Furthermore, the supply plan established by the supply planning system 100 or may be transmitted to other system via the network.

1. A supply planning system for establishing a supply plan by specifying variable values among the variable values which satisfy a predetermined constraint condition, aiming to optimize values of calculation formulas of multiple evaluation indexes,
the system further comprising a controller for repeatedly executing, if the number of the evaluation indexes is larger than a predetermined threshold;
a processing for calculating a value range of each of the calculation formulas respectively for two evaluation indexes, in association with the variable values satisfying the constraint condition, the two evaluation indexes being specified from the multiple evaluation indexes,
a processing for calculating a weighting factor by which the calculation formula of one evaluation index out of the two evaluation indexes being specified is multiplied, so that when the one evaluation index is multiplied by the weighting factor, the value range of the calculation formula of the one evaluation index in association with the variable values satisfying the constraint condition becomes larger than the value range of the calculation formula of the other evaluation index in association with the variable values satisfying the constraint condition, and
a processing for multiplying the calculation formula of the one evaluation index by the weighting factor and adding a result of the multiplication to the calculation formula of the other evaluation index, thereby synthesizing the two evaluation indexes to obtain one evaluation index.

2. The supply planning system according to claim 1, wherein,
when the calculation formula of the one evaluation index is multiplied by the weighting factor, and the value range of the calculation formula of the one evaluation index in association with the variable values satisfying the constraint condition exceeds a predetermined figure length, the controller synthesizes other two evaluation indexes without synthesizing the two evaluation indexes being specified.

3. The supply planning system according to claim 1, wherein,
each of the evaluation index is assigned with a priority, and
the controller repeatedly executes a processing for specifying a combination of two evaluation indexes in accordance with the priority sequentially from the lowest one, and assigning the one evaluation index with a priority higher than a priority of the other evaluation index in the combination in order to synthesize the two evaluation indexes included in the combination, as to each combination sequentially from the combination having a lower priority, until the number of the evaluation indexes becomes equal to or less than the threshold.

4. The supply planning system according to claim 1, wherein,
each of the evaluation index is assigned with a priority, and
the controller repeatedly executes a processing for specifying two evaluation indexes in accordance with the priority sequentially from the lowest one, and assigning the one evaluation index with a priority higher than a priority of the other evaluation index in order to synthesize the two evaluation indexes into one evaluation index, making the priority of the one evaluation index to be the priority of the other evaluation index, until the number of the evaluation indexes becomes equal to or less than the threshold.

5. The supply planning system according to claim 1, wherein,
the controller assumes that the weighting factor is obtained by adding an arbitrary positive value to a difference value between a maximum value and a minimum value in the value range of the calculation formula of the other evaluation index in association with the variable values satisfying the constraint condition.

6. The supply planning system according to claim 1, wherein,
the controller accepts inputting of the threshold via an input section.

7. The supply planning system according to either claim 3 or claim 4, wherein,
the controller accepts inputting of the priority via an input section.

8. The supply planning system according to claim 7, wherein,
the controller accepts inputting of the priority via the input section, so as to make the priorities into multiple patterns, and synthesizes the evaluation indexes for each of the multiple patterns.

9. The supply planning system according to claim 8, wherein,
the controller establishes the supply plan for each of the multiple patterns so as to optimize the multiple evaluation indexes including the evaluation indexes being synthesized, and outputs the supply plan being established to an output section, in a predetermined display format.

10. A program which allows a computer to function as a supply planning system for establishing a supply plan by specifying variable values among the variable values which satisfy a predetermined constraint condition, aiming to optimize values of calculation formulas of multiple evaluation indexes,
the program further allowing a control means to repeatedly execute, if the number of the evaluation indexes is larger than a predetermined threshold;
a processing for calculating a value range of each of the calculation formulas respectively for two evaluation indexes, in association with the variable values satisfying the constraint condition, the two evaluation indexes being specified from the multiple evaluation indexes,
a processing for calculating a weighting factor by which the calculation formula of one evaluation index out of the two evaluation indexes being specified is multiplied, so that when the one evaluation index is multiplied by the weighting factor, the value range of the calculation formula of the one evaluation index in association with the variable values satisfying the constraint condition becomes larger than the value range of the calculation formula of the other evaluation index in association with the variable values satisfying the constraint condition, and
a processing for multiplying the calculation formula of the one evaluation index by the weighting factor and adding a result of the multiplication to the calculation formula of the other evaluation index, thereby synthesizing the two evaluation indexes to obtain one evaluation index.

11. The program according to claim 10, wherein,
when the calculation formula of the one evaluation index is multiplied by the weighting factor, and the value range of the calculation formula of the one evaluation index in association with the variable values satisfying the constraint condition exceeds a predetermined figure length, the control means is allowed to synthesize other two evaluation indexes without synthesizing the two evaluation indexes being specified.

12. The program according to claim 10, wherein,
each of the evaluation index is assigned with a priority, and
the control means is allowed to repeatedly executes a processing for specifying a combination of two evaluation indexes in accordance with the priority sequentially from the lowest one, and assigning the one evaluation index with a priority higher than a priority of the other evaluation index in the combination in order to synthesize the two evaluation indexes included in the combination, as to each combination sequentially from the combination having a lower priority, until the number of the evaluation indexes becomes equal to or less than the threshold.

13. The program according to claim 10, wherein,
each of the evaluation index is assigned with a priority, and
the control means repeatedly executes a processing for specifying two evaluation indexes in accordance with the priority sequentially from the lowest one, and assigning the one evaluation index with a priority higher than a priority of the other evaluation index in order to synthesize the two evaluation indexes into one evaluation index, making the priority of the one evaluation index to be the priority of the other evaluation index, until the number of the evaluation indexes becomes equal to or less than the threshold.

14. The program according to claim 10, allowing the control means to assume that the weighting factor is obtained by adding an arbitrary positive value to a difference value between a maximum value and a minimum value in the value range of the calculation formula of the other evaluation index in association with the variable values satisfying the constraint condition.

15. The program according to claim 10, allowing the control means to accept inputting of the threshold via an input section.

16. The program according to either claim 12 or claim 13, allowing the control means to accept inputting of the priority via an input section.

17. The program according to claim 16, allowing the control means to accept inputting of the priority via the input section, so as to make the priorities into multiple patterns, and to synthesize the evaluation indexes for each of the multiple patterns.

18. The program according to claim 17, allowing the control means to establish the supply plan for each of the multiple patterns so as to optimize the multiple evaluation indexes including the evaluation indexes being synthesized, and outputs the supply plan being established to an output section, in a predetermined display format.

19. A synthetic method for synthesizing evaluation indexes, the method being performed by a supply planning system including a controller for establishing a supply plan by specifying variable values among the variable values which satisfy a predetermined constraint condition, aiming to optimize values of calculation formulas of multiple evaluation indexes, wherein,
if the number of the evaluation indexes is larger than a predetermined threshold, the controller repeatedly executes;
a step of calculating a value range of each of the calculation formulas respectively for two evaluation indexes, in association with the variable values satisfying the constraint condition, the two evaluation indexes being specified from the multiple evaluation indexes,
a step of calculating a weighting factor by which the calculation formula of one evaluation index out of the two evaluation indexes being specified is multiplied, so that when the one evaluation index is multiplied by the weighting factor, the value range of the calculation formula of the one evaluation index in association with the variable values satisfying the constraint condition becomes larger than the value range of the calculation formula of the other evaluation index in association with the variable values satisfying the constraint condition, and
a step of multiplying the calculation formula of the one evaluation index by the weighting factor and adding a result of the multiplication to the calculation formula of the other evaluation index, thereby synthesizing the two evaluation indexes to obtain one evaluation index.
